(19) United States
(12) Patent Application Publication
(10) Pub. No.: US 2026/0091807 A1
(43) Pub. Date: Apr. 2, 2026

(54) REAL TIME TRAJECTORY PLANNING SYSTEM WITH DYNAMIC MODELLING OF COMPONENT LEVEL SYSTEM LATENCY FOR SELF DRIVING VEHICLES

(71) Applicant: Tesla, Inc., Austin, TX (US)

(72) Inventors: Paril JAIN, Austin, TX (US); Theo GUERIN, Austin, TX (US); Lukas Lao BEYER, Austin, TX (US); Ashok Kumar ELLUSWAMY, Austin, TX (US)

(73) Assignee: Tesla, Inc., Austin, TX (US)

(21) Appl. No.: 19/104,619

(22) PCT Filed: Aug. 18, 2023
(86) PCT No.: PCT/US2023/030610

§ 371 Date: Feb. 18, 2025

Related U.S. Application Data
(60) Provisional application No. 63/373,039, filed on Aug. 19, 2022.

(51) Int. Cl. B60W 60/00; B60W 50/06

(52) U.S. Cl. CPC B60W 60/0015; B60W 50/06; B60W 2420/403; B60W 2510/20; B60W 2520/105; B60W 2520/125

(57) ABSTRACT

Systems and methods for autonomous driving which calculates path trajectories by incorporating latencies of vehicle components and calculations so that when the vehicle is in an autonomous driving mode and using a trajectory to calculate a designated path, the latencies of each vehicle component can be taken into account to provide a more accurate vehicle path.

### CROSS-REFERENCE TO RELATED APPLICATION

This application claims priority to U.S. Provisional Patent Application No. 63/373,039 titled “TRAJECTORY PLANNER REAL TIME TRAJECTORY PLANNING SYSTEM WITH DYNAMIC MODELLING OF COMPONENT LEVEL SYSTEM LATENCY FOR SELF DRIVING VEHICLES” and filed on Aug. 19, 2022, the disclosure of which is hereby incorporated herein by reference in its entirety.

### TECHNICAL FIELD

Embodiments of the present disclosure relate to systems and methods for providing a driving trajectory planner system with an optimized trajectory. More specifically, embodiments of the present disclosure relate to systems and methods for optimizing a driving path, such as a driving trajectory as part of an autonomous driving system.

### BACKGROUND

Generally described, computing devices and communication networks can be utilized to exchange data and/or information. In a common application, a computing device can request content from another computing device via the communication network. For example, a computing device can collect various data and utilize a software application to exchange content with a server computing device via the network (e.g., the Internet).

A variety of vehicles, such as electric vehicles, combustion engine vehicles, hybrid vehicles, etc., can be configured with various sensors and components to facilitate the operation of the vehicle or management of one or more systems included in the vehicle, such as an autonomous driving system (e.g., a self-driving systems). In certain scenarios, a vehicle owner or vehicle user may wish to utilize sensor-based systems to facilitate the operation of the vehicle's autonomous driving system. For example, vehicles can often include hardware and software functionality that facilitates autonomous driving by utilizing location services or accessing computing devices that provide location services. In another example, vehicles can also include navigation systems or access navigation components that can generate information related to navigational or directional information provided to vehicle occupants and users. In still further examples, vehicles can include vision systems to facilitate autonomous driving by utilizing navigational and location services, safety services or other operational services/components.

### BRIEF DESCRIPTION OF THE DRAWINGS

This disclosure is described herein with reference to drawings of certain embodiments, which are intended to illustrate, but not to limit, the present disclosure. It is to be understood that the accompanying drawings, which are incorporated in and constitute a part of this specification, are for the purpose of illustrating concepts disclosed herein and may not be to scale.

FIG. 1 depicts a block diagram of an illustrative environment for vision systems in vehicles in accordance with one or more aspects of the present application;

FIG. 2A depicts a block diagram of an illustrative environment that corresponds to vehicles in accordance with one or more aspects of the present application;

FIG. 2B an illustrative vision system for a vehicle in accordance with one or more aspects of the present application;

FIG. 3 depicts a block diagram of an illustrative architecture for implementing a planning component in accordance with aspects of the present application;

FIGS. 4A, 4B and 4C are block diagrams of the illustrative environment of FIG. 1 and illustrates the generation of simulated model content and the subsequent generation of a set of vision system training data for machine learning processes based on simulated model content;

FIG. 5A is a block diagram of an illustrative interaction of controlling a vehicle;

FIG. 5B is an example of a data pipeline that represents latencies in commanding a vehicle;

FIG. 5C is an illustrative example of using estimated latencies of lateral and longitudinal control in the trajectory representation; and

FIG. 5D is a line graph showing an illustrative example of driving by modeling the optimization trajectory with accounting for, and without accounting for, a system delay.

### DETAILED DESCRIPTION

Although certain preferred embodiments and examples are disclosed below, the inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations, in turn, in a manner that may be helpful in understanding certain embodiments; however, the order of description should not be construed to imply that these operations are order-dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Software, as well as hardware, components of self-driving vehicles, will have some inherent latency when evaluated from the first timestamp at which sensor measurements are obtained to final actuation (steering, accel pedal, brakes) due to time spent on computations, communication across different modules, hardware actuation, and so on. In order to provide a system which can autonomously or semi-autonomously drive an autonomous vehicle like a human and to make accurate decisions in safety critical scenarios, a planning and decision-making system should consider the latency of each such component into the temporal decision-making process. Hence, the system described herein is configured to accurately model the latency of final actuations-such as steering, braking, or acceleration independently and accurately. In addition, the design should be efficient enough to avoid spending unnecessary milliseconds performing calculations to determine a new decision; otherwise, it will make the system latency and reaction time worse than if the unnecessary calculations were not performed.

Embodiments of the invention relate to a trajectory planning system that can run in real-time on a safety-critical system, such as an autonomous vehicle, and be capable of accurate modeling of vehicle behavior when the latency of individual actuator components is taken into consideration.

In brief, some embodiments of the disclosed system can be embedded in an autonomous vehicle and may perform one or more following processes to control operation parameters for autonomously driving the vehicle:
1. Sensor measurements from a specific sensor suite are processed by a perception system to generate information regarding surrounding information (e.g., world information) of around the vehicle. The surrounding information can include, and is not limited to, surrounding objects information, road type information, driving direction information, and the like.
2. A planning (e.g., decision-making) system may utilize the outputs of the perception system to derive several semantic decisions that the autonomous vehicle should follow. The planning system, based on the derived semantic decision, may generate a high-fidelity trajectory plan (position, velocity, heading, curvature, longitudinal acceleration, lateral acceleration, longitudinal jerk, lateral jerk).
3. A control embedded in the vehicle system may utilize the trajectory plan and generate autonomous driving commands, such as speed and steering commands which can be used to control the vehicle.
4. The generated steering command can be utilized by a vehicle steering command unit, such as an electronic power assist ECU that serves as the motor controller for a steering motor to steer the direction of the vehicle.
5. The speed, accel and jerk commands are sent to a vehicle motor controller, to convert the commands to final torque for the motor or the brake pressure for the vehicle braking system to control the speed, position and direction of the vehicle.

In some embodiments, a vehicle planning and control system may perform one or more of these processes. Using this methodology, the planning and control system for an autonomous vehicle receives a representation of the world around it as measured by a sensor suite (e.g., a set of sensors implemented in the vehicle) and processed with a perception system. The purpose of the planning system is to make decisions and plan a trajectory to achieve certain goals for the self-driving vehicle, such as a decision-making progress along a desired navigation route while maintaining a safe and comfortable ride. The trajectory that the planning system generates is sent to a controller, which calculates speed and steering commands for actuators to accurately track the planning system's output trajectory. The vehicle planning and control system may generally be referred to as a planning system, and the planning system can be implemented as a planning component of the vehicle.

Embodiments of the present application correspond to systems and methods for providing a driving trajectory planner system in vehicles by optimizing the trajectory of an autonomous vehicle while taking into account the latencies required to process the data within the system as the vehicle is in an autonomous driving mode. Optimizing or optimization, as referred to herein, may include classical calculation techniques along with machine learning (e.g., neural network) based techniques. The trajectory can be generally referred to as an anticipated driving trajectory of the vehicle. More specifically, the systems and methods are used to optimize the trajectory in an autonomous driving system before entering the trajectory. The trajectory information can be determined by utilizing a navigation service, such as the global positioning system, and based on data received from cameras and other sensors installed in the vehicle. For example, a user (e.g., a driver) may input a destination location on the vehicle navigation system, and then an autonomous driving system installed in the vehicle may determine one or more driving paths to the destination. In this example, the vehicle's autonomous system may determine a path to reach the destination. As the autonomous vehicle is driving towards the destination, the vehicle will continuously compute an optimal trajectory based on road conditions, other vehicles, traffic signals, pedestrians, etc., to safely steer the vehicle to the destination. The trajectory may be calculated, for example, every few milliseconds so that the autonomous vehicle can change its path directly or speed to account for the current road conditions.

Traditionally, a vehicle's autonomous driving system is associated with physical sensors that provide inputs to the autonomous system. For example, the physical sensors may include imaging systems and hardware processors and memory to support those imaging systems. In addition, the autonomous system may include radar systems, LIDAR systems, etc., that are able to detect the distance to objects and characterize attributes of the detected objects. These components may have inherent latencies in evaluating data generated from these sensors to utilize in autonomous driving (e.g., self-driving) of the vehicle. Each of these hardware components may also have a different latency that reflects the time for the component to manage its data and send that data to the system, calculating the current trajectory of the vehicle. In addition, the system itself has a latency in calculating the proper path for the vehicle as the vehicle is being autonomously driven. These latencies may cause challenges for determining driving paths or an optimal trajectory because each of the sensors, navigation system, communication path (e.g., communication bus), or processors may be acting upon data captured at slightly different times as the vehicle is driving. In addition, the system may be calculating routes based on outdated information since the vehicle or surrounding environment may have changed during the few milliseconds that the system is calculating the preferred driving path. For example, where surrounding other vehicles are changing their driving path, the autonomous system may not simultaneously determine the optimal trajectory in the changing environment due to a latency in detecting and computing data that detects the other vehicles' driving path changes.

In one application, these latencies are problematic in determining a vehicle path, such as a vehicle trajectory. For example, the vehicle's autonomous system, based on processing data received from various sensors, may plan the driving trajectory in advance of the vehicle driving on the calculated trajectory. In this example, by the time the trajectory planning is completed, and control commands are actuated to move the vehicle into a desired state (e.g., speed and steering angle), the vehicle may have moved to a state that differs from the initial state around which the planning system began its planning due to the latencies. The latencies can generally be referred to as time delays caused by some portion of data used as input data for the planning component of the vehicle. For example, the delay of some portions of the data can be caused by the operational delay of sensors, communication delay, sensor data processing delay, etc. For instance, if the planning system generates a desired trajectory that requires vehicle acceleration, then the vehicle may not achieve this acceleration until downstream systems have processed and acted on this request. Subsequently, the vehicle's sensor system may not measure a vehicle acceleration that corresponds to the desired trajectory's acceleration until the downstream systems have processed and acted on this request. If this latency between desired vehicle behavior encoded in the planning system's trajectory is large relative to the durations and time-criticality of the maneuvers that the planning system would like to achieve, then it can lead to inaccurate decision-making and trajectory planning.

To address at least a portion of the above deficiencies, aspects of the present application relate to using a planning system that is trained to account for the latencies of the various components within the vehicle. If each vehicle uses a planning system that is configured to incorporate the various component latencies as it generates path information, then the system may properly calculate the trajectory of the vehicle as it drives along its designated path to its destination.

General aspects of the present application are related to determining (or estimating) latencies for each of the hardware components and software model implemented in the system and using the determined latencies in a decision-making logic. In these aspects, the system may utilize various neural network-based planning systems.

In some embodiments, the system is configured to determine latencies corresponding to each hardware component and software model utilized in autonomous driving of a vehicle. For example, if the vehicle is utilizing front, side, and rear cameras in autonomous driving, the system determines each latency corresponding to each of these cameras. In this example, the system may also determine any computational latency caused by the software or systems that process data received from these cameras to use in autonomous driving. In some embodiments, these latencies are utilized in a temporal decision-making process of autonomous driving. In these embodiments, based on these latencies, the system determines an accurate time sequence of data received or processed from each hardware component or software model. For example, if a front camera, sides cameras, and rear camera have 1 ms, 2 ms, and 3 ms latencies, respectively, the images captured by the front camera, sides cameras, and rear camera, 1 ms, 2 ms, and 3 ms before a reference time, respectively, can be utilized as images at the reference time, where the images are used in the autonomous driving. These hardware components and software models are merely provided as examples, and various hardware components configurations and software models can be used based on application.

In some embodiments, the system provides a real-time determination of the optimal trajectory while operating the vehicle, such as in autonomous driving environments. In these embodiments, the system can provide a real-time calculation of the optimal trajectory while accounting for each component's latency in combining one or more data received from the navigation system and/or sensors installed in the vehicle. For example, a deep neural network (DNN) may be trained as part of the autonomous system and may output component latency.

In some embodiments, the optimal trajectory can be provided by utilizing the trained planning system or model. The optimal trajectory can be referred to an optimal driving path and its associated vehicle operational parameters, such as position, velocity, heading, curvature, longitudinal acceleration, lateral acceleration, longitudinal jerk, lateral jerk, that can provide comfort, safety, and efficient driving. The planning model implemented in the planning component of the vehicle can determine the optimal trajectory path by utilizing data from one or more sensors installed in the vehicle and by utilizing a navigation system or service. In some embodiments, the planning model may simulate multiple trajectories and determine an optimal trajectory of the vehicle's operating parameters. In these embodiments, the determination is based on determining the vehicle's operating parameters corresponding to each simulated trajectory. For example, the planning model may generate the vectorized model for each simulated result and determine the vehicle operating parameters for each vectorized model. Then, the planning model may determine an optimal trajectory that can provide comfort, safety, and efficient driving. In some embodiments, the planning model may predict any possible latency caused by sensors and computational processors. In these embodiments, based on the predicted latencies, the planning model may distribute the computational resources to account for these latencies.

In some embodiments, the autonomous system installed in the vehicle relies solely on vision systems for determining an optimal trajectory. Illustratively, the vision-only systems are in contrast to vehicles that may combine vision-based systems with one or more additional sensor systems, such as radar-based systems, LIDAR-based systems, SONAR systems, and the like. In some embodiments, Vision-only systems can be configured with machine learned processes that can process inputs solely from vision systems, including a plurality of cameras mounting on the vehicle. The machine learned process can generate outputs identifying objects and specifying characteristics/attributes of the identified objects, such as position, velocity, and acceleration measured relative to the vehicle. The outputs from the machine learned processes could then be utilized for further processing, such as for navigational systems, locational systems, safety systems, and the like.

In accordance with aspects of the present application, a network service can configure the machine learned process in accordance with a supervised learning model in which a machine learning process is trained with labeled data, including identified objects and specified characteristics/attributes, such as position, velocity, acceleration, and the like. The first portion of the training data set corresponds to data collected from target vehicles that include vision systems, such as the vision systems included in the vision-only system in the vehicles. Additionally, a second portion of the training data corresponds to additional information obtained from other systems, namely, a simulated content system that can generate video images and associated attribute information.

Illustratively, a network service can receive the combined set of inputs (e.g., the first data set and the second data set) from a target vehicle, including both vision and simulated content. The network service then combines the data based on a standardized data format. Illustratively, the combined data sets allow the supplementing of the previously collected vision data with additional information or attribute/characteristics that may not have been otherwise available from processing the vision data. The combined set of data can result in a set of data that tracks objects of a defined set of time based on the first and second sets of data. The network service can then process the combined data set using various techniques. Such techniques can include smoothing, extrapolation of missing information, applying kinetic models, applying confidence values, and the like. Thereafter, the network service generates an updated machine learned process based on training on the combined data set. The trained machine learned process may be transmitted to vision-only based vehicles or to target vehicles with both vision and detection systems for repeating the process and further updating/refining the machine learned process.

Although the various aspects will be described in accordance with illustrative embodiments and a combination of features, one skilled in the relevant art will appreciate that the examples and combination of features are illustrative in nature and should not be construed as limiting. More specifically, aspects of the present application may be applicable to various types of vehicles, including vehicles with different propulsion systems, such as combination engines, hybrid engines, electric engines, and the like. Still, further, aspects of the present application may be applicable to various types of vehicles that can incorporate different types of sensors, sensing systems, navigation systems, or location systems. Accordingly, the illustrative examples should not be construed as limiting. Similarly, aspects of the present application may be combined with or implemented with other types of components that may facilitate the operation of the vehicle, including autonomous driving applications, driver convenience applications and the like.

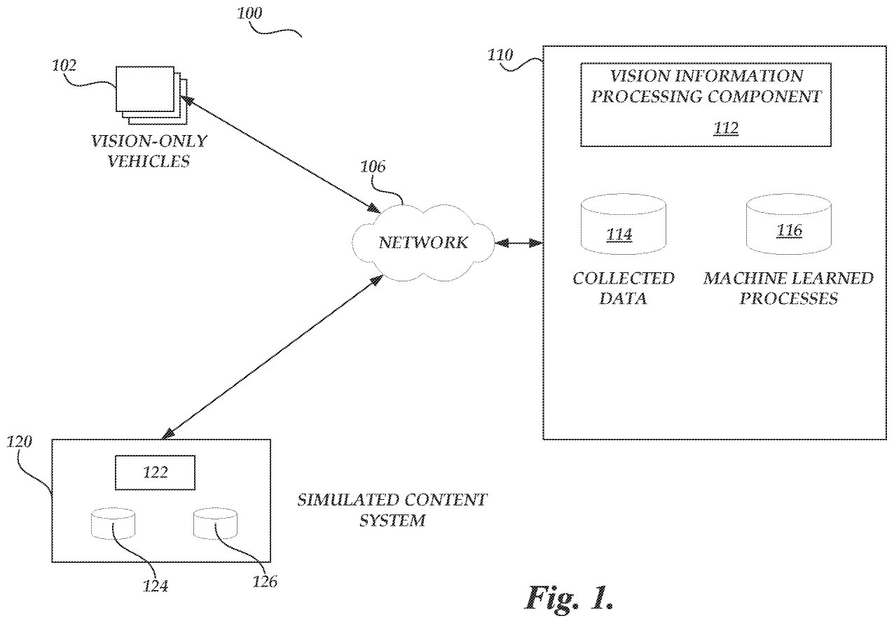

FIG. 1 depicts a block diagram of an illustrative environment 100 for generating simulated content models and training set data for vision systems in vehicles in accordance with one or more aspects of the present application. The system 100 can comprise a network, the network connecting a first set of vehicles 102, a network service 110, and a simulated content system 120. Illustratively, the various aspects associated with the network service 110 and simulated content system 120 can be implemented as one or more components that are associated with one or more functions or services. The components may correspond to software modules implemented or executed by one or more external computing devices, which may be separate stand-alone external computing devices. Accordingly, the components of the network service 110 and the simulated content system 120 should be considered as a logical representation of the service, not requiring any specific implementation on one or more external computing devices.

Network 106, as depicted in FIG. 1, connects the devices and modules of the system. The network can connect any number of devices. In some embodiments, a network service provider provides network-based services to client devices via a network. A network service provider implements network-based services and refers to a large, shared pool of network-accessible computing resources (such as compute, storage, or networking resources, applications, or services), which may be virtualized or bare-metal. The network service provider can provide on-demand network access to a shared pool of configurable computing resources that can be programmatically provisioned and released in response to customer commands. These resources can be dynamically provisioned and reconfigured to adjust to the variable load. The concept of “cloud computing” or “network-based computing” can thus be considered as both the applications delivered as services over the network and the hardware and software in the network service provider that provide those services. In some embodiments, the network may be a content delivery network.

Illustratively, the set of vehicles 102 correspond to one or more vehicles configured with vision-only based system for identifying objects and characterizing one or more attributes of the identified objects. The set of vehicles 102 are configured with machine learned processes, such as machine learned processes implemented in a supervised learning model, that are configured to utilize solely vision systems inputs to identify objects and characterize attributes of the identified objects, such as position, velocity, and acceleration attributes. The set of vehicles 102 may be configured without any additional detection systems, such as radar detection systems, LIDAR detection systems, and the like.

Illustratively, the network service 110 can include a plurality of network-based services that can provide functionality responsive to configurations/requests for machine learned processes for vision-only based systems as applied to aspects of the present application. As illustrated in FIG. 1, the network-based services 110 can include a planning component 212 that can obtain data sets from the vehicles 102 and the simulated content systems 120, process sets of data to form training materials for machine learning process and generate machine learned processes for vision-only based vehicles 102. The network-based service can include a plurality of data stores for maintaining various information associated with aspects of the present application, including a vehicle data store 114, and machine learned process data store 116. The data stores in FIG. 1 are logical in nature and can be implemented in the network service 110 in a variety of manners.

Similar to network service 110, the simulated content service 120 can include a plurality of network-based services that can provide functionality related to providing visual frames of data and associated data labels for machine learning applications as applied to aspects of the present application. As illustrated in FIG. 1, the network-based services 120 can include a scenario generation component 122 that can create various scenarios according to a set of defined attributes/variables. The simulated content service 120 can include a plurality of data stores for maintaining various information associated with aspects of the present application, including a scenario clip data store 124 and ground truth attribute data store 126. The data stores in FIG. 1 are logical in nature and can be implemented in the simulated content service in a variety of manners.

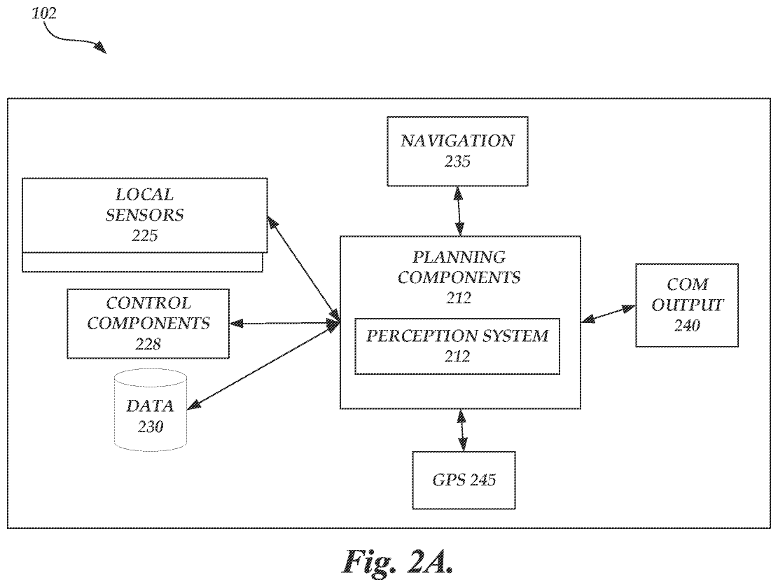

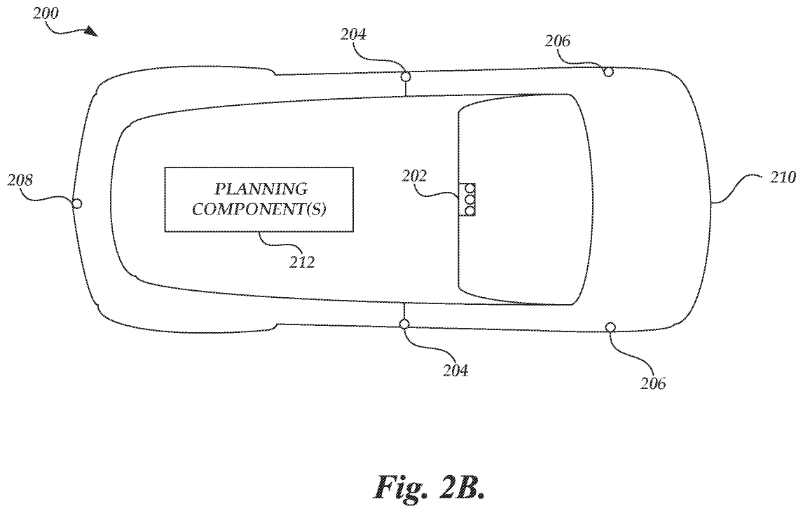

For purposes of illustration, FIG. 2A illustrates an environment that corresponds to a vehicle in the set of vehicles 102 in accordance with one or more aspects of the present application. The environment includes a collection of local sensors 225 that can provide inputs for the operation of the vehicle or collection of information as described herein. The collection of local sensors 225 can include one or more sensor or sensor-based systems included with a vehicle or otherwise accessible by a vehicle during operation. The local sensors 225 or sensor systems may be integrated into the vehicle. Alternatively, the local sensors or sensor systems may be provided by interfaces associated with a vehicle, such as physical connections, wireless connections, or a combination thereof.

In one aspect, the local sensors 225 can include vision systems that provide inputs to the vehicle, such as detection of objects, attributes of detected objects (e.g., position, velocity, acceleration), presence of environment conditions (e.g., snow, rain, ice, fog, smoke, etc.), and the like. An illustrative collection of cameras mounted on a vehicle to form a vision system will be described with regard to FIG. 2B. As previously described, the vehicle 102 will rely on such vision systems for defined vehicle operational functions without assistance from or in place of other traditional detection systems.

In yet another aspect, the local sensors 225 can include one or more positioning systems that can obtain reference information from external sources that allow for various levels of accuracy in determining positioning information for a vehicle. For example, the positioning systems can include various hardware and software components for processing information from GPS sources, Wireless Local Area Networks (WLAN) access point information sources, Bluetooth information sources, radio-frequency identification (RFID) sources, and the like. In some embodiments, the positioning systems can obtain combinations of information from multiple sources. Illustratively, the positioning systems can obtain information from various input sources and determine positioning information for a vehicle, specifically elevation at a current location. In other embodiments, the positioning systems can also determine travel-related operational parameters, such as direction of travel, velocity, acceleration, and the like. The positioning system may be configured as part of a vehicle for multiple purposes, including self-driving applications, enhanced driving or user-assisted navigation, and the like. Illustratively, the positioning systems can include planning components 212 linked to data 230 that facilitate the identification of various vehicle parameters or process information.

In still another aspect, the local sensors 225 can include one or more navigation systems 235 for identifying navigation related information. Illustratively, the navigation systems can obtain positioning information from positioning systems and identify characteristics or information about identified location data (e.g., received from the global positional system (GPS) 245), such as elevation, road grade, etc. The navigation systems 235 can also identify suggested or intended lane locations in a multi-lane road based on directions that are being provided or anticipated for a vehicle user. Similar to the location systems, the navigation system may be configured as part of a vehicle for multiple purposes including self-driving applications, enhanced driving or user-assisted navigation, and the like. The navigation systems may be combined or integrated with planning components 212 that are part of a positioning system.

The local resources may include one or more planning components 212 that may be hosted on the vehicle or a computing device accessible by a vehicle (e.g., a mobile computing device). The planning components 212 can illustratively access inputs from the local sensors 225 or sensor systems and process the inputted data as described herein. For purposes of the present application, the planning components 212 will be described with regard to one or more functions related to illustrative aspects. For example, planning components 212 in vehicle 102 will collect and transmit the first data set corresponding to the collected vision information.

The environment can further include various additional sensor components or sensing systems operable to provide information regarding various operational parameters for use in accordance with one or more of the operational states. The environment can further include one or more control components 228 for processing outputs, such as the transmission of data through a communications output 240, the generation of data in memory, the transmission of outputs to other planning components, and the like.

In accordance with one or more aspects as described herein, the planning components 212 can be configured to provide vehicle control instructions (e.g., steering, acceleration, pedal, brakes, velocity, etc.) by processing the sensor data with the estimation of inherent latencies, such as data computational latency, internal data communication latency, and hardware (e.g., steering actuator, motor, etc.) actuation latency. In some embodiments, the planning components 212 can include a perception system 212.

The perception system 212 can be configured to receive sensor data from the local sensors 225, navigation 235, and GPS 245. After receiving the sensor data, the perception system 212 can process the received data to determine the state of the vehicle, such as potion, heading, steering angle, velocity, longitudinal acceleration, and lateral acceleration. The planning components 212 may utilize the determined state of the vehicle to estimate the latencies and generate vehicle operational parameter control instructions. For example, the planning components 212 can categorize the vehicle states into lateral state and longitudinal state. The lateral state can refer to vehicle operation variables related to vehicle position, heading, steering angle, and steering angle rate. The longitudinal state can refer to vehicle operation variables related to vehicle speed, acceleration, longitudinal jerk, and longitudinal snap. The lateral state can be associated with controlling the vehicle steering actuator, and the longitudinal state can be associated with controlling the vehicle motor actuator. The planning components 212 can determine the latency for controlling individual steering and motor actuators. For example, the planning components 212 may determine the time latency between measuring the vehicle states and controlling individual steering and motor actuators. Example latencies may include time delay in receiving input data from the local sensors (e.g., measurement latency), processing of the local sensors' data (e.g., computation latency), transmitting and receiving the data between the components (e.g., communication latency), and operating the individual steering and motor actuator (e.g., hardware latency). The planning components 212, based on the determined latencies, may accurately plan the vehicle operation with vehicle trajectory optimization.

With reference now to FIG. 2B, an illustrative vision system 200 for a vehicle, will be described. The vision system 200 includes a set of cameras that can capture image data during the operation of a vehicle. As described above, individual image information may be received at a particular frequency such that the illustrated images represent a particular time stamp of images. In some embodiments, the image information may represent high dynamic range (HDR) images. For example, different exposures may be combined to form the HDR images. As another example, the images from the image sensors may be pre-processed to convert them into HDR images (e.g., using a planning model).

As illustrated in FIG. 2B, the set of cameras can include a set of front facing cameras 202 that capture image data. The front facing cameras may be mounted in the windshield area of the vehicle to have a slightly higher elevation. As illustrated in FIG. 2B, the front facing cameras 202 can include multiple individual cameras configured to generate composite images. For example, the camera housing may include three image sensors which point forward. In this example, the first of the image sensors may have a wide-angled (e.g., fish-eye) lens. A second of the image sensors may have a normal or standard lens (e.g., 35 mm equivalent focal length, 50 mm equivalent, and so on). A third of the image sensors may have a zoom or narrow lens. In this way, three images of varying focal lengths may be obtained in the forward direction by the vehicle. The vision system 200 further includes a set of cameras 204 mounted on the door pillars of the vehicle. The vision system 200 can further include two cameras 206 mounted on the front bumper of the vehicle. Additionally, the vision system 200 can include a rearward facing camera 208 mounted on the rear bumper, trunk or license plate holder.

The set of cameras 202, 204, 206, and 208 may all provide captured images to one or more planning components 212, such as a dedicated controller/embedded system. For example, the planning component 212 may include one or more matrix processors which are configured to rapidly process information associated with planning models. The planning component 212 may be used, in some embodiments, to perform convolutions associated with forwarding passes through a convolutional neural network. For example, input data and weight data may be convolved. The planning component 212 may include a multitude of multiply-accumulate units which perform the convolutions. As an example, the matrix processor may use input and weight data which has been organized or formatted to facilitate larger convolution operations. Alternatively, the image data may be transmitted to a general-purpose planning component. The planning component 212 can be referred to as an autonomous driving planning component.

Illustratively, the individual cameras may operate or be considered individually as separate inputs of visual data for processing. In other embodiments, one or more subsets of camera data may be combined to form composite image data, such as the trio of front facing cameras 202.

In some embodiments, the planning component 212 can process the captured images to determine a driving path, where the vehicle 200 is set to automatically drive to a destination designated by a user (e.g., driver) using a navigation system. In these embodiments, the planning component may simulate a plurality of driving paths at certain distances (e.g., in a certain number of time frames) and determine an optimized driving path in real-time. For example, if vehicle 200 needs to change lanes, the planning component 212 simulates a plurality of driving paths to change the lane based on the traffic lane and surrounding objects such as surrounding vehicles or any objects. Each simulated result can be vectorized based on vehicle operation parameters such as acceleration, speed, and velocity. Then, the planning component 212 can determine an optimum driving path by utilizing a planning system to change lanes. The planning system can be configured to analyze the vectorized results to determine an optimum driving path in changing lanes.

In some embodiments, the planning component 212 can determine an optimal trajectory when the vehicle 200 needs to move in trajectory direction during its autonomous driving. In these embodiments, when the vehicle 200 needs to move in a trajectory, such as turning to a specific direction, the planning component 212 can determine an optimal trajectory that can provide comfort, safety, and an efficient driving experience to the driver. For example, when the vehicle 200 needs to make a left turn, the planning component 212 may simulate a plurality of trajectories to make the turn. Each simulated trajectory can be vectorized based on vehicle operation parameters, such as acceleration, speed, and velocity, before the vehicle turns to the specification direction. Then, the planning component 212 can utilize a planning model to determine an optimal trajectory based on driving comfort, safety, and efficiency, and the vehicle utilizes the optimal trajectory in its autonomous driving.

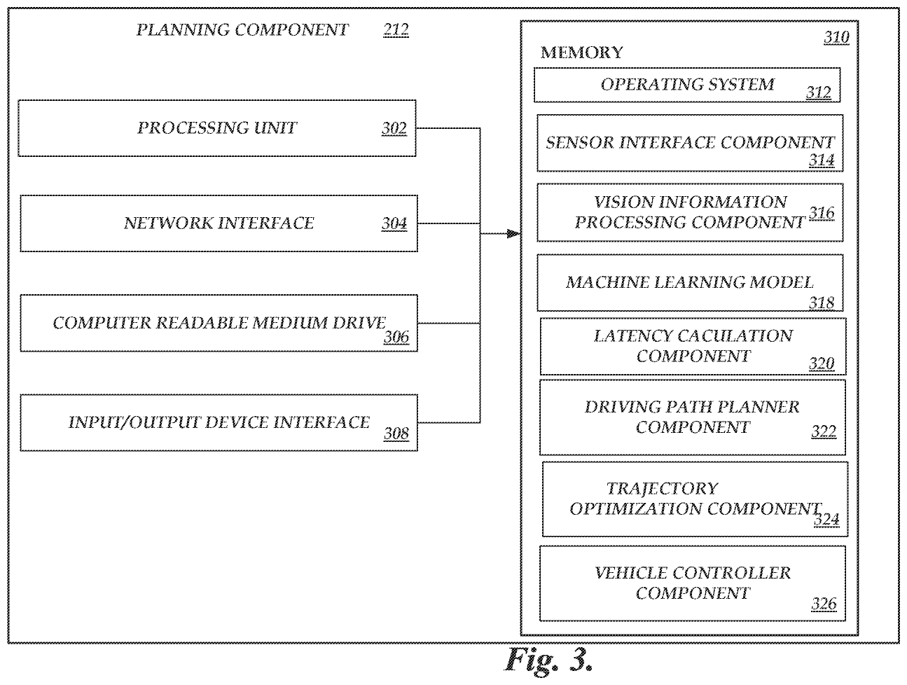

With reference now to FIG. 3, an illustrative architecture for implementing the planning component 212 on one or more local resources or a network service will be described. The planning component 212 may be part of components/systems that can provide functionality associated with autonomous driving.

The architecture of FIG. 3 is illustrative in nature and should not be construed as requiring any specific hardware or software configuration for the planning component 212. The general architecture of the planning component 212 depicted in FIG. 3 includes an arrangement of computer hardware and software components that may be used to implement aspects of the present disclosure. As illustrated, the planning component 212 includes a processing unit 302, a network interface 304, a computer readable medium drive 306, and an input/output device interface 308, all of which may communicate with one another by way of a communication bus. The components of the planning component 212 may be physical hardware components or implemented in a virtualized environment.

The network interface 304 may provide connectivity to one or more networks or computing systems, such as the network 106 of FIG. 1. The processing unit 302 may thus receive information and instructions from other computing systems or services via a network. The processing unit 302 may also communicate to and from memory 210 and further provide output information for autonomous driving via the input/output device interface. In some embodiments, the planning component 212 may include more (or fewer) components than those shown in FIG. 3.

The memory 310 may include computer program instructions that the processing unit 302 executes in order to implement one or more embodiments, The memory 310 generally includes RAM, ROM, or other persistent or non-transitory memory. The memory 310 may store an operating system 312 that provides computer program instructions for use by the processing unit 302 in the general administration and operation of the planning component 212. The memory 310 may further include computer program instructions and other information for implementing aspects of the present disclosure. For example, in one embodiment, the memory 310 includes a sensor interface component 316 that obtains information from vehicles, such as vehicles 102, data stores, other services, and the like

The memory 310 further includes a vision information planning component 316 for obtaining and processing the one or more sets of data, including simulated content in accordance with various operational states of the vehicle as described herein.

The memory 310 can further include a planning model 318 for generating or training machine learned processes for use in autonomous driving of the vehicles 102. In some embodiments, the planning model 318 uses the data coming from the vehicle systems to determine an optimal driving path and the vehicle's optimal operating parameter that can provide a comfort, safety, and efficient autonomous driving. In these embodiments, the planning model 318 can determine the vehicle's optimal operating parameters based on input received from a driving trajectory planner component 320 and trajectory optimization component 322. For example, the trajectory optimization component 322 may provide a plurality of possible trajectories in the form of a plurality of vectorized data that the vehicle can utilize to make a turn in a specific direction. In this example, the planning model 318 may analyze each trajectory's vectorized data based on the vehicle's operating parameters, such as the vehicle's velocity, speed, acceleration, etc. Then, the planning model 318 determines an optimal trajectory that can provide optimal driving in terms of comfort, safety, and efficiency of driving.

The memory 310 can further include the latency calculation component 320 for determining latency caused by hardware components or software models used for autonomous driving. The latency calculation component 320 can be implemented by utilizing the planning model 318. In some embodiments, the latency calculation component 320 may determine each latency caused by hardware components, such as cameras, sensors, or any system components related to a decision-making for autonomous driving. The latency calculation component 320 may further determine latency caused by any computational software model that processes data related to the decision-making for autonomous driving. In some embodiments, the calculated latencies can be used in an individual component or in a combination of components in the memory 310. In some embodiments, the calculated latencies can be updated in real-time.

The memory 310 can further include the driving trajectory planner component 322 for generating multiple driving paths that can be used in autonomous driving. In some embodiments, while the vehicle is operating in autonomous driving, the driving trajectory planner component 320 searches all possible driving paths in real-time. For example, when the vehicle needs to change a lane, the driving trajectory planner component 322 may generate multiple driving paths to change the lane. In this example, the vehicle may analyze its surrounding environments, such as other vehicles or any objects surrounding the vehicle. After determining the driving paths, the driving trajectory planner component 322 may convert each driving path into vectorized data, where the vectorized data is transmitted to the planning model 318.

The memory 310 can further include the trajectory optimization component 324 for generating multiple trajectories that can be used in autonomous driving when the vehicle needs to move in a direction. In some embodiments, when the vehicle needs to move in a direction, the trajectory optimization component 324 searches all possible trajectories in real-time. For example, when the vehicle needs to make a right turn, the trajectory optimization component 324 may generate multiple trajectories for turning to the right. In this example, the trajectory optimization component 324 may convert each driving path into vectorized data, where the vectorized data is transmitted to the planning model 318. In some embodiments, the trajectory optimization component 324 may represent a neural network which outputs a trajectory. For example, the neural network may be trained to output a trajectory based on input (e.g., the input may represent, at least, an output of a vision stack which outputs objects positioned about a vehicle).

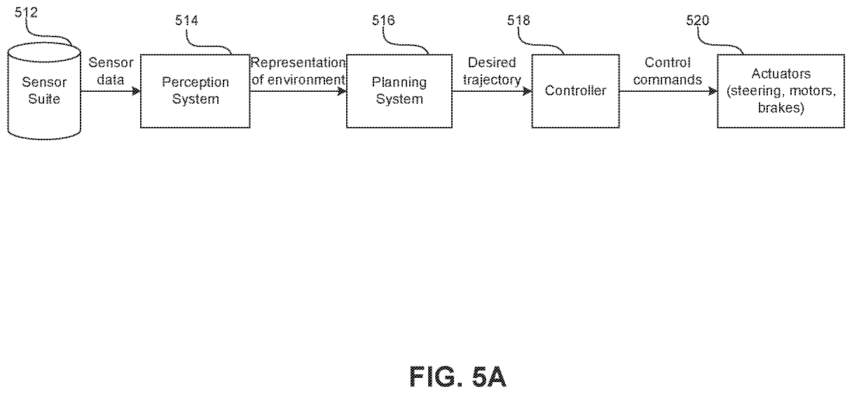

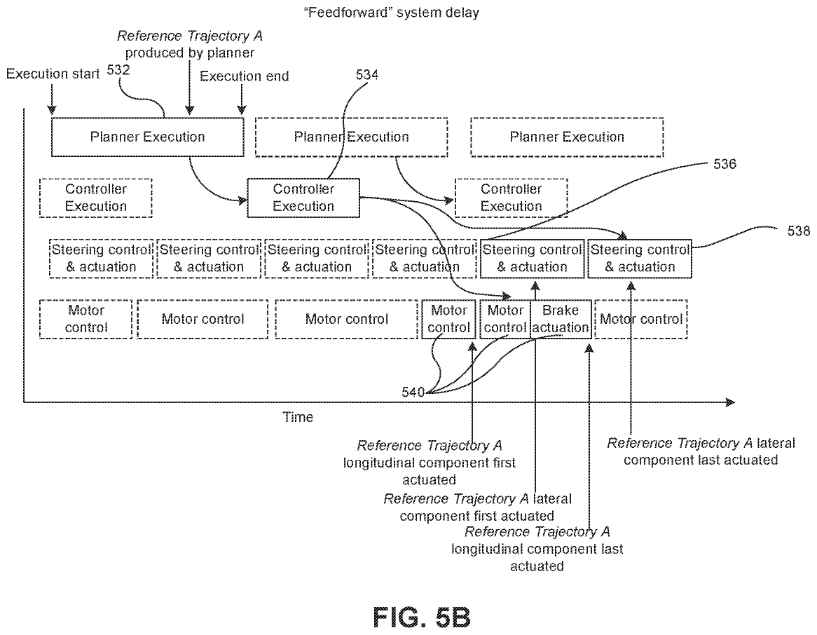

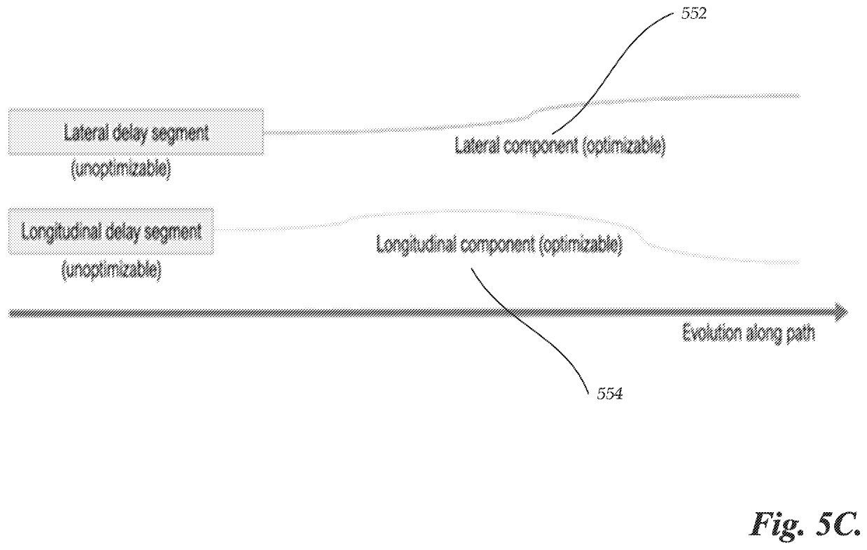

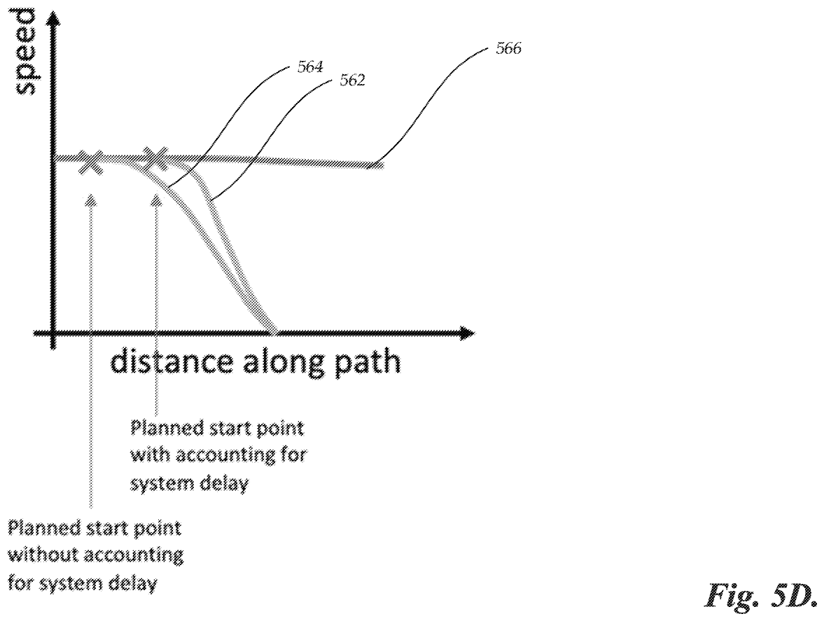

In some embodiments, the trajectory optimization component 324 may simulate the driving of the vehicle on the trajectories. In these embodiments, for each simulation on the individual trajectory, the trajectory optimization component 324 may generate a simulation result that includes, for example, data related to the position, velocity, heading, curvature, longitudinal acceleration, lateral acceleration, longitudinal jerk, or lateral jerk while driving on the driving path. The trajectory optimization component 324 may evaluate the fitness of the trajectory using an objective function whose value is maximized. In some embodiments, the memory 310 can further include a vehicle controller component 326 to control the vehicle to drive the vehicle on the trajectory path determined in the trajectory optimization component 324. In some embodiments, the vehicle controller component 326 generates commands related to the vehicle's operation, such as steering, acceleration, and braking. The commands, for example, include steering commands for controlling the steering motor and speed and acceleration commands for controlling the motor, and jerk commands for controlling the braking system. For example, based on the data (such as data related to the position, velocity, heading, curvature, longitudinal acceleration, lateral acceleration, longitudinal jerk, or lateral jerk) related to the trajectory path determined in the trajectory optimization component 324, the controller component 326 generate these commands. In one embodiment, the controller component 326 can be implemented as a stand-alone component, such as a controller. In some embodiments, the controller component 326 may implement classical and/or modern control techniques (e.g., a PID controller, non-linear control techniques, adaptive and learning techniques, and so on). In some embodiments, and as described in FIG. 5A, the controller component 326 may be removed such that component 324 may directly output commands (e.g., lower-level commands) for steering, acceleration, braking, and so on.

Although illustrated as components combined within the planning component 212, one skilled in the relevant art will understand that one or more of the components in memory 310 may be implemented in individualized computing environments, including both physical and virtualized computing environments.

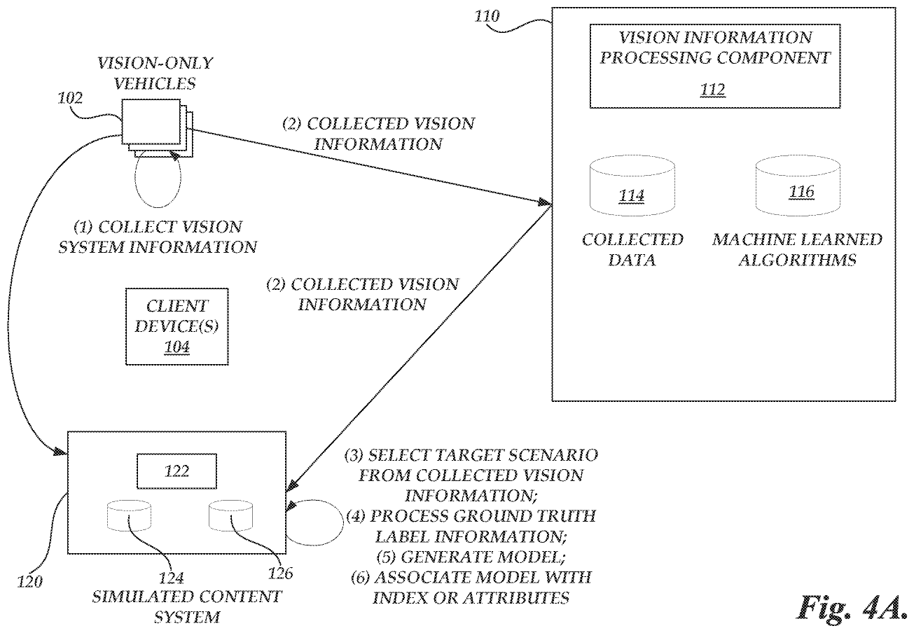

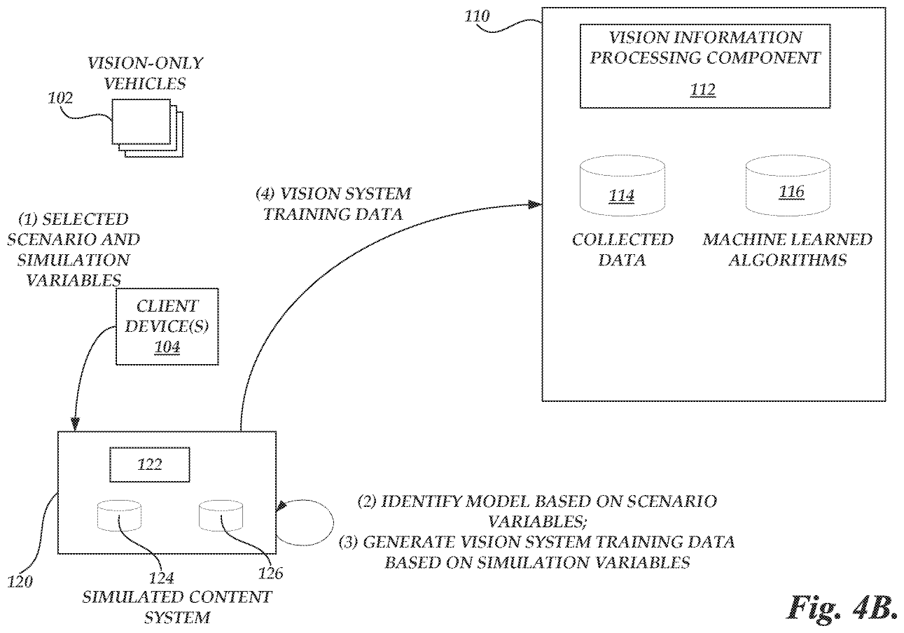

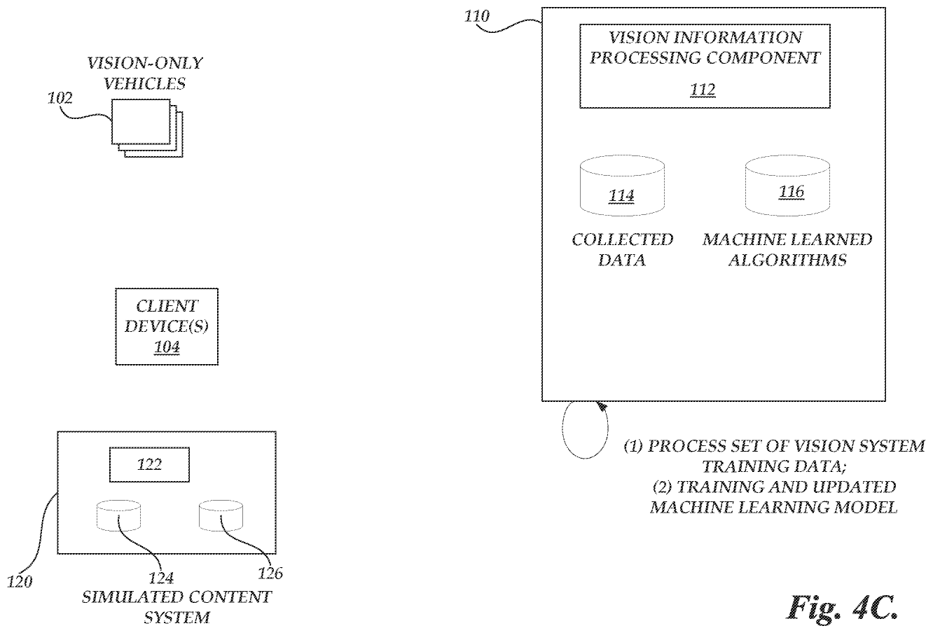

Turning now to FIGS. 4A-4C, illustrative interactions for the components of the environment to process vision system data and generate simulated content system data to update training models for machine learning processes will be described. At (1), one or more vehicles 102 can collect and transmit a set of inputs (e.g., the first data set). The first set of data illustratively corresponds to the video image data and any associated metadata or other attributes collected by the vision system 200 of the vehicle 102.

Illustratively, the vehicles 102 may be configured to collect vision system data and transmit the collected data. For example, the collected vision system data may be transmitted based on periodic timeframes or various collection/transmission criteria. Still further, in some embodiments, the vehicles 102 may also be configured to identify specific scenarios or locations, such as via geographic coordinates or other identifiers, that will result in the collection and transmission of the collected data. As shown in FIG. 4A, at (2), the collected vision system data may be transmitted to the simulated content service 122 directly from the vehicles 102 or indirectly through the network service 110.

At (3), the simulated content service 122 receives and processes the collected vision system data from the vehicles 102. Illustratively, the simulated content service 122 can process the vision-based data, such as to complete lost frames of video data, update version information, error correction, and the like. Additionally, at (3), the simulated content service 122 can further process the collected vision system data to identify ground truth labels for the captured video data. Illustratively, the ground truth labels can correspond to any one of a variety of detectable objects that may be depicted in the video data. In one embodiment, the ground truth label data can include information identifying road edges. Additionally, the ground truth label data can include information dependent on the identified road edge, such as lane lines, road centers and one or more stationary objects (e.g., road signs, markers, etc.). Still further, in some embodiments, the ground truth label data can include dynamic object data related to one or more identified objects, such as vehicles, dynamic obstructions, environmental objects, and the like.

At (4), the simulated content service 122 can process the ground truth label data. Illustratively, the simulated content service 122 can process the ground truth label according to a priority for identifying/extracting the core ground truth label data that will be used as the basis for the simulated content. Illustratively, the lane edge ground truth labels may be considered to have a high or higher priority. Additional ground truth label data, such as lane lines labels, lane center labels, static object labels, or dynamic object labels, may be associated with low or lower priority with regard to the lane label data or relative to each other. In some embodiments, the label data may be filtered to remove one or more labels (e.g., dynamic objects) that may be replaced by the simulated content or are otherwise not required to generate simulated content. For purposes of illustration, the processed set of ground truth label may be considered the content model attributes that will be for the simulated content.

At (5), the simulated content service 122 generates the model for the future generation of the simulated content. Illustratively, the simulated content service 122 can process the content attributes in a manner for error adjustment, extrapolation, variation, and the like.

At (6), the simulated content service 122 can generate index data or attribute data (e.g., metadata) for each clip or simulated content data that will facilitate selection, sorting or maintenance of the data. The index or attribute data can include identification of the location, the types of objects simulated, the number of variations that are generated/available, environmental conditions simulated, tracking information, origin source information, and the like. For purposes of FIG. 4A, the simulated content may be generated without specific request/need for the scenarios for training, which will be described with regard to FIG. 4B.

Referring to FIG. 4B, illustratively, the stored and indexed simulated content information can be provided to the network service 110 as part of training data. At (1), the simulated content service 122 can receive a selection or criteria for selecting the data. Illustratively, a computing device 104 may be utilized to provide criteria, such as sorting criteria. In some embodiments, the request for the simulated content is utilized to provide attributes of the simulated content. Accordingly, the generation of the simulated content can be considered to be responsive to the requests for simulated content in generating the simulated content itself. Thus, the generation of the simulated content may be considered synchronous in nature or dependent in nature. In other embodiments, the request may be a simple selection of the index values or attributes such that the simulated content service 122 can generate the simulated content based on pre-configure attributes or configurations that are not dependent with the individual requests for simulated content. Accordingly, generation of the simulated content may be considered independent relative to the request.

At (2), the network service 110 can then process the requests and identifies the generated simulated content models, such as via index data. At (3), the simulated content service 122 generates supplemental video image data and associated attribute data. Illustratively, the simulated content system 120 can utilize a set of variables or attributes that can be changed to create different scenarios or scenes for use as supplemental content. For example, the simulated content system 120 can utilize color attributes, types of object attributes, acceleration attributes, action attributes, time of data attributes, location/position attributes, weather condition attributes, and density of vehicle attributes to create various scenarios related to an identified object. Illustratively, the supplemental content can be utilized to emulate real-world scenarios that may be less likely to occur or be measured by the set of vehicles 102. For example, the supplemental content can emulate various scenarios that would correspond to unsafe or hazardous conditions.

The simulated content system 120 may illustratively utilize a statistical selection of scenarios to avoid repetition based on trivial differences (e.g., similar scenarios varying only by the color of the object) that would otherwise have the potential to bias a machine learning process. Additionally, the simulated content system simulated content service 122 to the number of supplemental content frames and distribution of differences in one or more variables. Illustratively, the output from the simulated content service 122 can include labels (e.g., ground truth information) identifying one or more attributes (e.g., position, velocity and acceleration) that can be detected or processed by the network service 110. In this regard, the simulated content data sets can facilitate detailed labels and can be dynamically adjusted as required for different machine learned training sets. At (4), the simulated content training sets are transmitted to the network service 110.

Turning now to FIG. 4C, once the network service 110 receives the training set, at (1) the network service 110 processes the training sets. At (2), the network service 100 generates an updated machine learned process based on training on the combined data set. Illustratively, the network service 110 can utilize a variety of planning models to generate updated machine learned processes.

With reference to FIG. 5A, a block diagram of an illustrative interaction of a controlling vehicle, will be described. As shown in FIG. 5A, the planning component 212 (shown in FIGS. 2A, 2B, and 3A) can receive a representation of the world (e.g., surrounding environment of the vehicle) around the vehicle as measured by a sensor suite 512 and processed with a perception system 514. The sensor suite may provide the sensors and cameras described in FIGS. 2A and 2B and also a processor to process the output data of these sensors. In some embodiments, the planning component 212 is configured to make decisions and plan a trajectory (e.g., a driving trajectory) to achieve certain driving criteria for the self-driving vehicle, such as decision-making progress along the desired navigation route while maintaining a safe and comfortable ride. In some embodiments, the trajectory that the planning component 212 generates is sent to a controller, which calculates speed and steering commands for actuators to accurately track the planning system's output trajectory. In these embodiments, the controller can generate commands related to the vehicle's operation, such as steering, acceleration, and braking. The commands, for example, include steering commands for controlling the steering motor and speed and acceleration commands for controlling motor, and jerk commands for controlling the braking system. For example, based on the trajectory that the planning component 212 generates, the controller component 326 generates these commands.

FIG. 5A illustrates an example of vehicle components to control vehicle operation parameters for autonomous driving. As shown in FIG. 5A, the vehicle can include some or all of sensor suite 512, perception system 514, planning system 516, controller 518, and actuators 520. These components are illustrative and provided as an example purpose, and the present application does not limit the system or components of the vehicle. In some embodiments, the sensor suite 512, going through the perception system 514, the planning system 516, and the controller 518 can be implemented as the planning component 212. In some embodiments, autonomous driving can be performed based on a collection of instructions for an autonomous processor implemented in the vehicle to execute in real-time while the vehicle is driving.

The sensor suite 512 may collect sensor data measured by various sensors implemented in the vehicle. For example, the sensor suite 512 may collect data from the local sensors 205, navigation 235, and GPS 245, as shown in FIG. 2A. The collected sensor data can be transmitted to the perception system 514. In some embodiments, the perception system 514 processes the collected data and determine current vehicle states, such as position, heading, steering angle, velocity, longitudinal acceleration, and lateral acceleration. In some embodiments, each of the current vehicle states can be utilized as input data to the autonomous processor (not shown in FIG. 5A), and the autonomous processor may generate vehicle control instructions based on the current vehicle states. In some embodiments, the generated instructions are not directly used to control the vehicle. Instead, the planning system 516 can further process the generated instructions to optimize the vehicle operation. For example, the planning system 516 can determine time latencies for controlling the vehicle actuators. The planning system 516 may determine a time latency to estimate overall system latency, for example the time latency may be selected as the highest, lowest, or measure of central tendency of the time latencies of the actuators or the highest, lowest, or measure of central tendency of the longitudinal or lateral latencies (e.g., actuators associated with longitudinal or lateral control). The system 516 may also determine a time latency for each vehicle actuator (e.g., steering and motor actuators). For example, each measured data by the local sensors 225, navigation 235, and GPS 245 (shown in FIG. 2A) may include time stamp, and the measured data can be used to control the steering and motor actuators. The planning system 516 can determine the latencies from measuring the data to actuate the steering and motor actuators. In some embodiments, even though the data are measured at the same time, the latencies are different for each actuator. For instance, the latencies can include time delay in receiving input data from the local sensors (e.g., measurement latency), processing of the local sensors' data (e.g., computation latency), transmitting and receiving the data between the components (e.g., communication latency), and operating the individual steering and motor actuator (e.g., hardware latency).

After estimating the latencies, the planning system 516 may initiate the instructions computation. For example, if the latencies to control the steering actuator is higher, the planning system 516, after receiving the instruction to control the motor actuator, may wait for the duration of the determined latencies to receive instruction related to the steering actuator. In some embodiments, the planning system 516 may update the received instructions for each steering and motor actuator. For example, the motor actuator control instruction is received earlier than the steering actuator control instruction (due to the different latencies), the planning system may reduce the motor speed if the later received steering actuator control instruction includes higher steering tilting angle. Once the planning system's 516 computation is completed, the result is sent, in some embodiments, to the controller 518 to compute control commands. In some embodiments, where the measured environment is changed, the planning system 516 may reinitiate a new cycle of computation by receiving new measurements from the perception system 514 and sending an updated vehicle operation instruction to the controller 518. For example, the cycle can be reinitiated when the vehicle driving trajectory is changed. These cycles or updating trajectories can be performed in real-time, such as repeatedly running in a computational loop. For example, the loop may include receiving new measurements from the sensor suite 512, collecting the measured data by the perception system 514, processing the collected data and determining a trajectory for navigating in the environment by the planning system 514, and converting to control commands by the controller 518. In some embodiments, the planning system 516 may directly output control commands to the actuators 520. For example, the planning system 516 may include a neural network which is trained to output the control commands. Thus, in some embodiments controller 518 may be optional or removed.

In some embodiments, at the start of each planning cycle (e.g., at the start of each loop), the planning system 516 may receive perception information, from the perception system 514, about the state of the vehicle (e.g., position, heading, steering angle, velocity, longitudinal acceleration, and lateral acceleration). The planning system 516 may use this state information to determine the trajectory information, such as start of the trajectory that will be planned in the current cycle. In some embodiments, this state information can be used to estimate how far along the previous cycle's trajectory the vehicle has traveled, based on the vehicle's state information at the traveled point along the previous cycle's trajectory, by using a process called “feedforward.” In these embodiments, this state along the previous cycle's trajectory at which the current cycle's trajectory planning is initiated is called the feedforward state. The feedforward can enable the current cycle's trajectory planning to be consistent with the planning system's previously planned trajectories. In some embodiments, a self-driving vehicle system with an architecture that contains a trajectory planning system and a controller, the output trajectory from the planning system can be considered a “reference” for the controller to track, such that the controller can use feedback from vehicle state information to account for unmodeled disturbances and minimize tracking error with respect to the reference trajectory. In these embodiments, the controller may minimize deviations between the planned trajectory and the measured state of the vehicle, while the trajectory planning system may generate trajectories that make incremental progress toward higher-level planning goals (e.g., staying in the center of the lane, completing a turning maneuver, etc.).

In some embodiments, the planning component 212 may use nonlinear optimization, or a machine learning model (e.g., a neural network), to find a trajectory that is (1) feasible (e.g., adheres to constraints imposed by vehicle kinematics such as maximum turn radius or actuation limits such as minimum and maximum acceleration and jerk), (2) safe (e.g., adheres to constraints imposed by road geometry by avoiding collisions with curbs, following lane markings, maintaining a safe following distance with respect to lead vehicles and reacting appropriately by offsetting or slowing down any object, vehicle, person or animal along the planned trajectory), and (3) comfortable to the end user (e.g., exhibits similar characteristics of human-driven trajectories, such as preferring shorter, smoother paths requiring the least amount of steering action or acceleration). In these embodiments, a mathematical formulation of this optimization can involve representing the trajectory as a function of several optimizable parameters. For example, in order to accurately model the different delays of the steering system and the drive motor control system, state variables and control inputs along the trajectory can be split up, in some embodiments, into lateral and longitudinal components. In some embodiments, the planning component 212 may produce the trajectory by utilizing two separate mathematical functions describing the evolution along the path of (1) lateral control related state variables and control inputs (position, heading, steering angle, steering angle rate, steering angle angular acceleration) and (2) longitudinal control related state variables (time at the current distance along the path, speed, acceleration, longitudinal jerk, longitudinal snap). Utilizing the nonlinear optimization, which refines an initial guess of the trajectory's parameters to arrive at an optimized solution, the value of an objective function scoring the trajectory according to the criteria laid out earlier can be maximized iteratively. Because of the separation of the trajectory's lateral and longitudinal components into two separate functions, it can be possible to exactly constrain their initial portions in a way that models the estimated latency of lateral and longitudinal actuators.

With reference to FIG. 5B, an example of a data pipeline that represents latencies in commanding the vehicle is described. In the example, as shown in FIG. 5B, the horizontal axis represents time, thus, the width of each block may represent the latency corresponding to each block. In some embodiments, the planning component 212 can generate a trajectory in a “Planner Execution” block 532 and then send it to the “Controller Execution” block 534, which will send commands to the “Steering control & actuation” and “Motor control/Brake actuation” blocks 536-540. In some embodiments, block 532 can send commands to blocks 536-540 without block 534 (e.g., the component 532 can output commands via a neural network trained to control actuators). In these embodiments, since the actuator-specific blocks 536-540 represent different actuators, their actuation latencies to achieve desired control values can differ, represented by different widths of these control blocks along the time axis. In some embodiments, in addition to these actuation latencies, the planning component 212 can highlight algorithm runtime and phase delay between different components due to the scheduling of computations, all of which can contribute to latency downstream of the planner execution start.

With reference to FIG. 5C, an illustrative example of using estimated latencies of lateral and longitudinal control in the trajectory representation is described. In some embodiments, the planning component 212 can maintain estimates of and anticipate latencies (as shown in FIG. 5B) to generate a trajectory that more accurately represents how the vehicle's future state will evolve. For example, in the current planning cycle, the planning component 212 can recognize that the previous planning cycle's output trajectory may still be in the process of being actuated to achieve desired control values (e.g., desired commanding vehicle). The planning component 212 may set its initial portions of trajectory to match portions from the previous cycle's trajectory output. In doing so, the planning component 212 may model a process that the current and very near-term evolution of the vehicle's state may not be influenced immediately by the planning component 212's output. Instead, the planning component 212 can initiate its decision-making and trajectory optimization from near-future points in time, estimating that it will be at these points in time that the downstream processes and actuators will be able to move the vehicle in response to the current planning component 212's output. In some embodiments, the planning component 212 can initiate its decision-making process from the estimated future states at the end of the estimated latency durations, including starting the trajectory optimization at these estimated future states. In these embodiments, since the trajectory formulation can be split into lateral and longitudinal components 552, 554, the planning component 212 can also incorporate the estimated lateral and longitudinal delay segments in a decoupled manner, as illustrated in FIG. 5C. The decoupling of the lateral and longitudinal components 552, 554, according to the different latencies of the different actuators, can be utilized to maintain responsiveness of the lower-latency actuator path while achieving better accuracy of the trajectory optimization model.

In some embodiments, quantities in the trajectory optimization's objective function that depend on both the lateral and the longitudinal component of the trajectory (for example, lateral acceleration, which depends on both the vehicle's velocity and the curvature of the path) can be evaluated. In these embodiments, the trajectory optimization can account for the possibly different lateral and longitudinal delay segment lengths to ensure that the optimizable quantities along the two trajectory components are evaluated at aligned points along the evolution of the trajectory. In some embodiments, the delay segments at the initial portions of the lateral and longitudinal trajectory components, modeled as fixed based on the previous cycle's trajectory, may not be optimizable by the trajectory optimization. While description of FIG. 5C focused on latency associated with lateral and longitudinal components, in some embodiments the planning component 212 may estimate overall system latency using one of the components. As an example, the component 212 may output control signals which combine lateral and longitudinal control (e.g., the component 212 may represent a machine learning model, such as a neural network). For this example, the component 212 may therefore determine latency associated with this overall control. Optionally, the planning component 212 may estimate the overall system latency based on selecting the highest, lowest, or measure of central tendency of the components 552, 554.

With reference to FIG. 5D, an illustrative example of driving by modeling the optimization trajectory with accounting system delay, is described. In some embodiments, accuracy of the system model in both the lateral and longitudinal components 552, 554 (shown in FIG. 5C) may provide commanding the vehicle with optimal safety and comfort driving. As shown in FIG. 5D, without accounting for estimated feedforward system delay, the trajectory optimization 562 may be less accurate, as it may plan a maneuver, such as a sudden slowdown, which it may try to complete with less deceleration and jerk than may be needed to come to a stop within the desired distance along the path. As shown in FIG. 5D, a planning component 212 that accounts for an estimate of the delay of its longitudinal actuation can recognize that it may need to use more severe deceleration and jerk to achieve the desired behavior, and it can plan such a trajectory 564 for the controller to track with less tracking error due to the more accurate modeling of system delay. In the example, trajectory 566 represents when there was no sudden slowdown. In some embodiments, using a longitudinal delay segment that is decoupled from the lateral delay segment can avoid the possibility of, for example, introducing artificial latency in the system response if the lateral control latency is longer than the longitudinal control latency. In addition to improving the safety of the vehicle by more accurately modeling the system's response in the planning component 212, this modeling of system latency can improve ride comfort: with actuator outputs that can generally be more consistent with what the planning component 212 desired and modeled via its generated trajectory, the planning component 212 can control ride smoothness and generally expect the actuators to more accurately follow the desired trajectory.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed decision and control processes. It is to be understood that the forms of disclosure herein shown and described are to be taken as representative embodiments. Equivalent elements, materials, processes, or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer those two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application.

What is claimed is:

1. A system for planning a trajectory of a vehicle for autonomous driving, the system including one or more processors and non-transitory computer storage media storing instructions that when executed by the one or more processors cause the one or more processors to perform operations comprising, during a cycle:
obtaining vehicle data from a set of sensors;
identifying vehicle trajectory information and vehicle states by processing the obtained vehicle data;
identifying vehicle control instructions based on the identified vehicle trajectory information and the vehicle states, wherein the vehicle states are associated with operation of at least one actuator,
determining the vehicle control instructions for each actuator;
characterizing latencies for each actuator, wherein the latencies are estimated time delay between obtaining the vehicle data and controlling its corresponding actuator;
optimizing the vehicle control instructions based on the characterized latencies for each actuator based on the trajectory information; and
causing control of the vehicle based on the optimized vehicle control instructions.

2. The system of claim 1, wherein the cycle corresponds to a vehicle driving trajectory, and wherein a new cycle initiated upon the vehicle entering into a new trajectory.

3. The system of claim 1, wherein the trajectory information indicates a start of the trajectory, and wherein the vehicle states at the start of the trajectory are matched with vehicle states that controlled by the optimized vehicle control instructions in a previous cycle.

4. The system of claim 1 wherein the operations further comprise identifying an optimal trajectory path in prior to optimizing the vehicle control instructions, wherein the vehicle control instructions are generated based on the optimal trajectory path.

5. The system of claim 1, wherein the actuators include lateral component and longitudinal component, and wherein the lateral component is associated with operation of a steering actuator, and wherein the longitudinal component is associated with operation of a motor actuator.

6. The system of claim 5, wherein the estimated latencies correspond to the longitudinal component is lower than the lateral component, and wherein the system delay the optimization of the vehicle control instructions for a duration of the estimated latencies correspond to the lateral component.

7. The system of claim 1, wherein the vehicle trajectory information is identified by identifying geographic coordinates and collecting vision system data, and wherein the vision system data includes ground truth labels for captured video images by cameras implemented in the vehicle.

8. The system of claim 1, wherein the vehicle states include current vehicle position, heading, steering angle, velocity, longitudinal acceleration, and lateral acceleration.

9. The system of claim 1, wherein each of the obtained vehicle data includes time stamp that represents a measured time of each vehicle data.

10. The system of claim 9, wherein the latencies are estimated by determining a time difference between the time stamp of each vehicle data and a specific time of its corresponding actuator operation.

11. The system of claim 1, wherein the latencies include a measurement latency, a computation latency, a communication latency, and a hardware latency.

12. The system of claim 1, wherein the system is configured to determine the trajectory information based on the identified vehicle states.

13. The system of claim 1, wherein the optimization is based on predetermined criteria, the criteria comprising: vehicle kinematics, safety constraints, and comfortability constraints.

14. A system for planning vehicle trajectory, the system comprising:
a sensor suite configured to collect vehicle data from vehicle sensors implemented in a vehicle;
a perception system configured to generate vehicle states by receiving and processing the collected vehicle data from the sensor suite; and
a planning system configured to:
identify vehicle control instructions for the generated vehicle states;
determine latencies to control each actuator of the vehicle; and
optimize a trajectory of the vehicle based on determined latencies.

15. The system of claim 14, wherein the vehicle states includes vehicle trajectory information, and wherein the planning system optimizes the vehicle trajectory information based on the determined latencies for each actuator.

16. The system of claim 14, wherein the optimization is based on predetermined criteria, the criteria comprising: vehicle kinematics, safety constraints, and comfortability constraints.

17. The system of claim 14, wherein the system plans the vehicle trajectory for each cycle, and wherein a new cycle initiated upon the vehicle entering into a new trajectory.

18. The system of claim 14, wherein vehicle includes two actuations that correspond to lateral component and longitudinal component of the vehicle, and wherein the lateral component is associated with operation of a steering actuator, and wherein the longitudinal component is associated with operation of a motor actuator.

19. A method for planning trajectory, the method comprising:
obtaining vehicle data from a set of sensors;
identifying vehicle trajectory information and vehicle states by processing the obtained vehicle data;
identifying vehicle control instructions based on the identified vehicle trajectory information and the vehicle states, wherein the states are associated with operation of at least one actuator;
determining the vehicle control instructions for each actuator;
characterizing latencies for each actuator, wherein the latencies are estimated time delay between obtaining the vehicle data and controlling a corresponding actuator;
optimizing the trajectory information based on the characterized latencies for each actuator; and
causing control of the vehicle based on the optimized trajectory.

20. The method of claim 19, wherein causing control of the vehicle is based on identifying vehicle control instructions for driving the vehicle using the optimized trajectory information.

21. The method of claim 19, wherein the optimization is based on predetermined criteria, the criteria comprising: vehicle kinematics, safety constraints, and comfortability constraints.
